(19) United States
(12) Patent Application Publication
(10) Pub. No.: US 2025/0272601 A1
(43) Pub. Date: Aug. 28, 2025

(54) ARTIFICIAL INTELLIGENCE TRAINING USING ACCESIBILITY DATA

(71) Applicant: Oracle International Corporation, Redwood Shores, CA (US)

(72) Inventors: Rajani Kolli, San Jose, CA (US); Dan Foley, Redmond, WA (US); Pritesh Kothari, Fremont, CA (US)

(21) Appl. No.: 18/585,753

(22) Filed: Feb. 23, 2024

(51) Int. Cl. G06N 20/00

(52) U.S. Cl. CPC G06N 20/00

(57) ABSTRACT

Examples provide an electronic device including at least one electronic processor configured to request first accessibility data associated with a first user interface (“UI”) displayed by a first device and including at least one of (a) information identifying one or more UI elements in the first UI or (b) information identifying one or more UI events in the first UI; train, based on at least the first accessibility data and an error state associated with the first device, an artificial intelligence (“AI”) model; request second accessibility data associated with a second UI displayed by a second device and including (a) information identifying one or more UI elements in the second UI or (b) information identifying one or more UI events in the second UI; and detect, based on at least the second accessibility data and the AI model, the error state on the second device.

### FIELD

Embodiments described herein generally relate to training artificial intelligence models.

### SUMMARY

Conventional helpdesk bots integrated with a helpdesk service used for troubleshooting errors in software applications are trained only on text-based diagnostics provided directly by an end-user, and, as a result, are often ineffective at identifying and solving issues that the end-user experiences. For example, an end-user experiencing an error state on an end-user device may not know what information to provide a helpdesk bot, and the helpdesk bot may lack access to operational data associated with the endpoint device. These conventional helpdesk bots are therefore only marginally improved over coded troubleshooting trees. As a result, users in an organization often rely on a manual helpdesk process to troubleshoot errors, which may lack the resources to efficiently troubleshoot errors. Additionally, such helpdesks are typically only used to troubleshoot and solve errors after errors have occurred, rather than prevent the future occurrence of such errors.

Thus, there is a need for improved troubleshooting of endpoint devices using an artificial intelligence (“AI”) model trained on near real-time data from, for example, an accessibility interface in conjunction with telemetry, logs, and state information provided by an endpoint agent to learn, troubleshoot, resolve, and validate resolutions to endpoint device error states. This solution allows the AI model to perform new approaches to troubleshooting, modify solutions, and implement solutions to multiple devices within an organization—even before all such devices experience an error.

For example, one example provides an electronic device including at least one electronic processor configured to: make a first call via an accessibility application programming interface (“API”) to request first accessibility data associated with a first user interface (“UI”) displayed by a first device; receive the first accessibility data via the accessibility API, the first accessibility data comprising at least one of (a) information identifying one or more UI elements in the first UI or (b) information identifying one or more UI events in the first UI; train, based on at least the first accessibility data and an error state associated with the first device, an artificial intelligence (“AI”) model; make a second call via the accessibility API to request second accessibility data associated with a second UI displayed by a second device; receive the second accessibility data via the accessibility API, the second accessibility data comprising (a) information identifying one or more UI elements in the second UI or (b) information identifying one or more UI events in the second UI; and detect, based on at least the second accessibility data and the AI model, the error state on the second device.

In some aspects, the error state of the first device is reported through a helpdesk service.

In some aspects, the at least one electronic processor is further configured to determine the error state of the first device based on at least first endpoint management data, the first endpoint management data including state information of the first device.

In some aspects, the AI model is further trained based on at least a solution to the error state, and wherein the at least one electronic processor is further configured to: output, based on at least the AI model, a command to an agent executing on the second device to implement the solution on the second device.

In some aspects, the solution includes at least one selected from a group consisting of restarting at least one application executing on the second device, modifying an application configuration of at least one application of the second device, and modifying a network configuration of the second device.

In some aspects, the AI model is further trained based on first endpoint management data and a solution to the error state, the first endpoint management data including state information of the first device, wherein the at least one electronic processor is further configured to: predict, based on at least the AI model and second endpoint management data including state information of a third device, an occurrence of the error state on the third device; and output, based on at least the AI model, a command to an agent executing on the third device to preemptively implement the solution on the third device.

In some aspects, the at least one electronic processor is further configured to: receive third endpoint management data after outputting the command, the third endpoint management device including state information of the third device; and train the AI model based on at least the third endpoint management data.

In some aspects, the information identifying the one or more UI elements in the first UI includes at least one selected from the group consisting of: (a) a respective element type of the one or more UI elements in the first UI, (b) a respective identifier of the one or more UI elements in the first UI, or (c) a respective state or condition of the one or more UI elements in the first UI.

In some aspects, the information identifying the one or more UI elements in the first UI is organized as a hierarchical tree.

In some aspects, the one or more UI elements in the first UI comprises a first UI element that includes a second UI element; the hierarchical tree comprises a first hierarchical level that is above a second hierarchical level; the first hierarchical level includes a first node representing the first UI element; and the second hierarchical level includes a second node representing the second UI element.

In some aspects, the information identifying the one or more UI events in the first UI includes one or more notifications of changes in states or conditions of the UI elements in the first UI.

In some aspects, the first call made via the accessibility API is made to a platform rendering the first UI.

In some aspects, the platform includes one of an operating system executing on the first device or a browser application executing on the first device.

In some aspects, the first accessibility data is generated based on metadata associated with the one or more UI elements in the first UI, the metadata being exposed via the accessibility API.

In some aspects, the metadata is specified in one of (a) application code of application for which the first UI is being rendered or (b) content code of web content for which the first UI is being rendered.

In some aspects, the metadata specifies hierarchical relationships between the one or more UI elements in the first UI.

In some aspects, the first accessibility data is generated by a platform executing on the first device during rendering of the first UI.

Another example provides a method for training an artificial intelligence (“AI”) model for error troubleshooting. The method includes making a first call via an accessibility application programming interface (“API”) to request first accessibility data associated with a first user interface (“UI”) displayed by a first device; receiving the first accessibility data via the accessibility API, the first accessibility data comprising at least one of (a) information identifying one or more UI elements in the first UI or (b) information identifying one or more UI events in the first UI; training, based on at least the first accessibility data and an error state associated with the first device, the AI model; making a second call via the accessibility API to request second accessibility data associated with a second UI displayed by a second device; receiving the second accessibility data via the accessibility API, the second accessibility data comprising (a) information identifying one or more UI elements in the second UI or (b) information identifying one or more UI events in the second UI; and detecting, based on at least the second accessibility data and the AI model, the error state on the second device.

In some aspects, the method further includes training the AI model based on at least a solution to the error state; and outputting, based on at least the AI model, a command to an agent executing on the second device to implement the solution on the second device.

Another example provides an electronic device including at least one electronic processor configured to: make a first call via an accessibility application programming interface (“API”) to request first accessibility data associated with a first user interface (“UI”) displayed by a first device; receive the first accessibility data via the accessibility API, the first accessibility data comprising at least one of (a) information identifying one or more UI elements in the first UI or (b) information identifying one or more UI events in the first UI; train an artificial intelligence (“AI”) model based on at least the first accessibility data, an error state associated with the first device, and endpoint management data associated with the first device, the endpoint management data including state information of the first device; and predict, based on at least the AI model and second endpoint management data including state information of a second device, an occurrence of the error state on the second device.

Other aspects will become apparent by consideration of the detailed description and accompanying drawings.

### BRIEF DESCRIPTION OF THE DRAWINGS

FIG. 1 is a block diagram illustrating one pattern for implementing a cloud infrastructure as a service system, according to at least one embodiment.

FIG. 2 is a block diagram illustrating another pattern for implementing a cloud infrastructure as a service system, according to at least one embodiment.

FIG. 3 is a block diagram illustrating another pattern for implementing a cloud infrastructure as a service system, according to at least one embodiment.

FIG. 4 is a block diagram illustrating another pattern for implementing a cloud infrastructure as a service system, according to at least one embodiment.

FIG. 5 is a block diagram illustrating an example computer system, according to at least one embodiment.

FIG. 6 is a block diagram illustrating a system architecture for troubleshooting errors, according to at least one embodiment.

FIG. 7A illustrates an example accessibility data tree, according to at least one embodiment.

FIG. 7B illustrates an example details portion of a selected UI element of the accessibility data tree of FIG. 7A, according to at least one embodiment.

FIG. 8 is a flowchart illustrating an example method for training an artificial intelligence model to detect error states, according to at least one embodiment.

FIG. 9 is a flowchart illustrating an example method for training an artificial intelligence model to predict error states, according to at least one embodiment.

### DETAILED DESCRIPTION

In the following description, various embodiments will be described. For purposes of explanation, specific configurations and details are set forth to provide a thorough understanding of the embodiments. However, it will also be apparent to one skilled in the art that the embodiments may be practiced without the specific details. Furthermore, well-known features may be omitted or simplified in order not to obscure the embodiment being described.

### Cloud-Based Computing Platforms

Embodiments described herein may performed, wholly or partly, within a cloud-based computing platform. Cloud-based computing platforms provide scalable and flexible computing resources for users. Infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

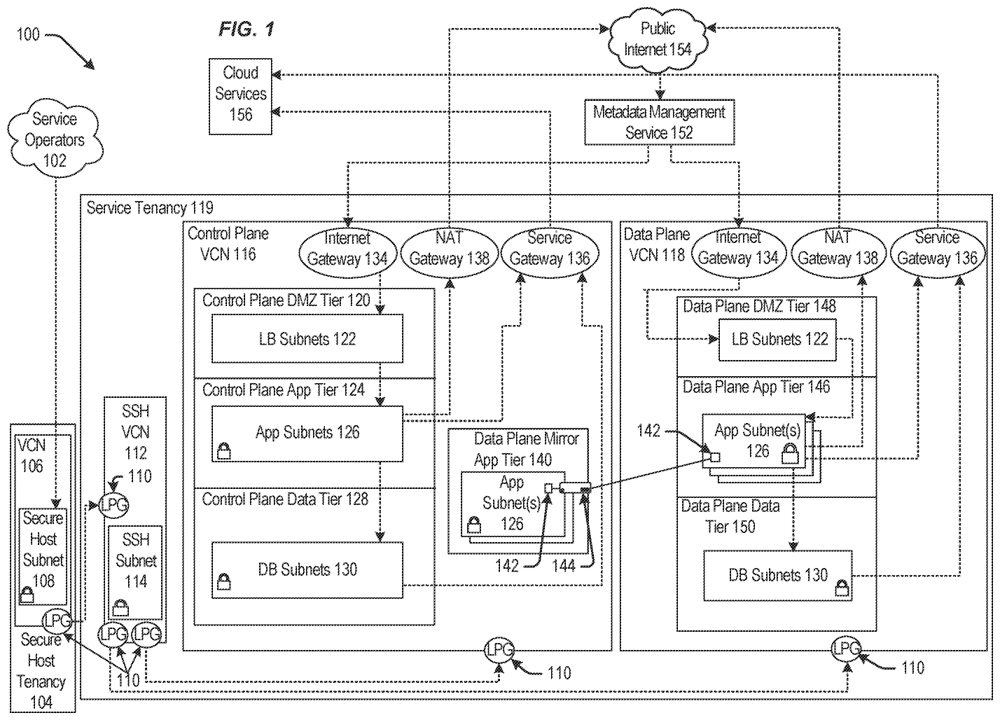

FIG. 1 is a block diagram 100 illustrating an example pattern of an IaaS architecture, according to at least one embodiment. Service operators 102 can be communicatively coupled to a secure host tenancy 104 that can include a virtual cloud network (VCN) 106 and a secure host subnet 108. In some examples, the service operators 102 may use one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116, and the app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively coupled to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way: the service gateway 136 can make API calls to cloud services 156, and cloud services 156 can send requested data to the service gateway 136. But, cloud services 156 may not initiate API calls to the service gateway 136.

In some examples, the secure host tenancy 104 can be directly connected to the service tenancy 119, which may be otherwise isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response to this determination, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118, both of which may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154, which may not have a desired level of threat prevention, for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119, which may be isolated from public Internet 154.

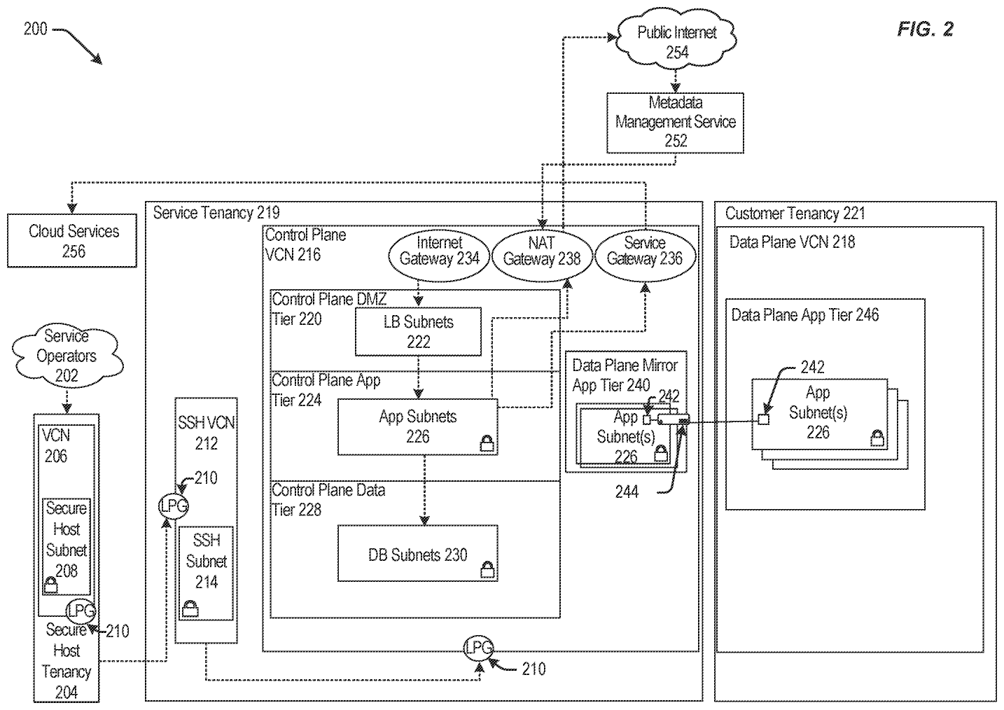

FIG. 2 is a block diagram 200 illustrating another example pattern of an IaaS architecture, according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216, and the app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively coupled to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique compute instance 244 that is contained in the service tenancy 219. Each compute instance 244 may allow communication between the control plane VCN 216, contained in the service tenancy 219, and the data plane VCN 218 that is contained in the customer tenancy 221. The compute instance 244 may allow resources, that are provisioned in the control plane VCN 216 that is contained in the service tenancy 219, to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment, or other usage of resources, of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1,” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

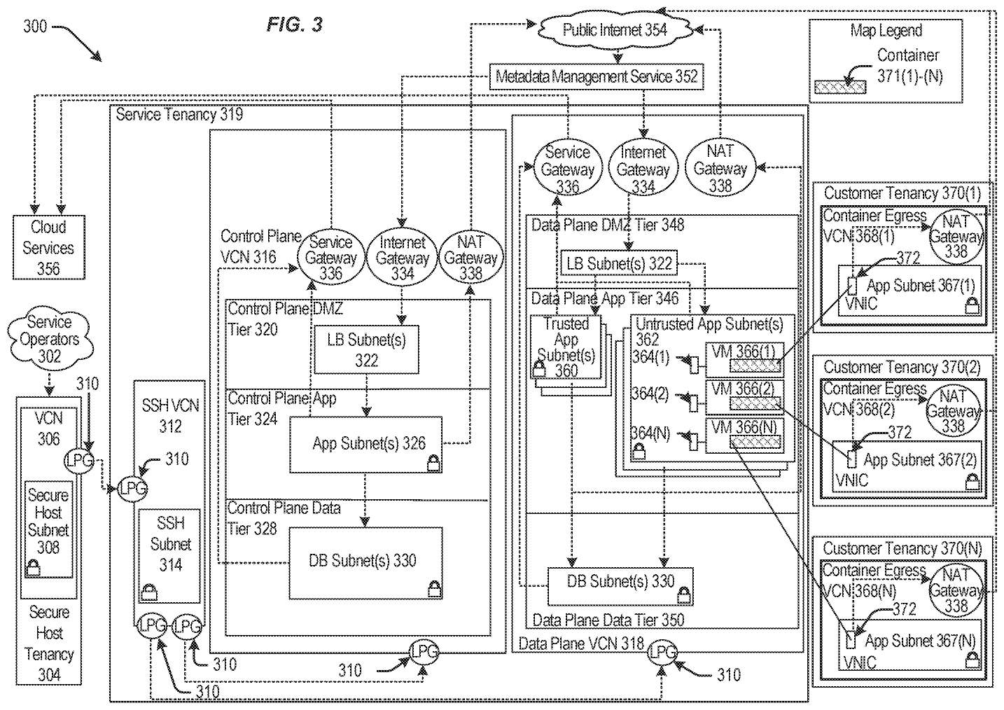

FIG. 3 is a block diagram 300 illustrating another example pattern of an IaaS architecture, according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360 and untrusted app subnet(s) 362 of the data plane app tier 346 and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 370(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management system 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively coupled to cloud services 356.

In some embodiments, the data plane VCN 318 can be integrated with customer tenancies 370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 370. Respective containers 371(1)-(N) contained in the VMs 366(1)-(N) may be configured to run the code. In this case, there can be a dual isolation (e.g., the containers 371(1)-(N) running code, where the containers 371(1)-(N) may be contained in at least the VM 366(1)-(N) that are contained in the untrusted app subnet(s) 362), which may help prevent incorrect or otherwise undesirable code from damaging the network of the IaaS provider or from damaging a network of a different customer. The containers 371(1)-(N) may be communicatively coupled to the customer tenancy 370 and may be configured to transmit or receive data from the customer tenancy 370. The containers 371(1)-(N) may not be configured to transmit or receive data from any other entity in the data plane VCN 318. Upon completion of running the code, the IaaS provider may kill or otherwise dispose of the containers 371(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 371(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

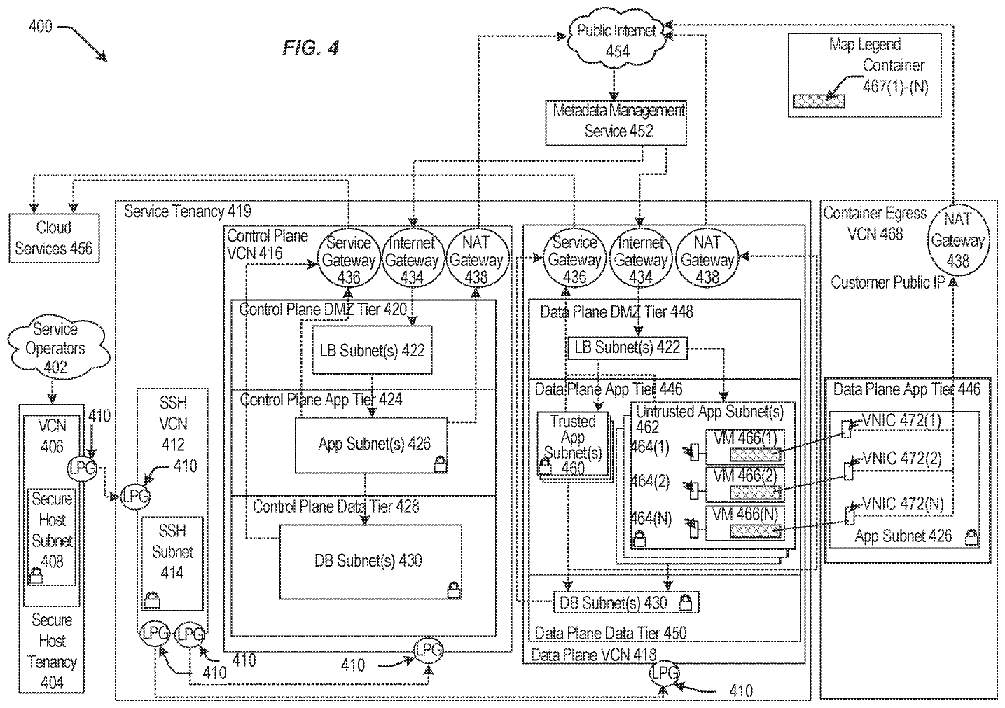

FIG. 4 is a block diagram 400 illustrating another example pattern of an IaaS architecture, according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N), and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management system 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively coupled to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real-time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that requests a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, 400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

### Computer System

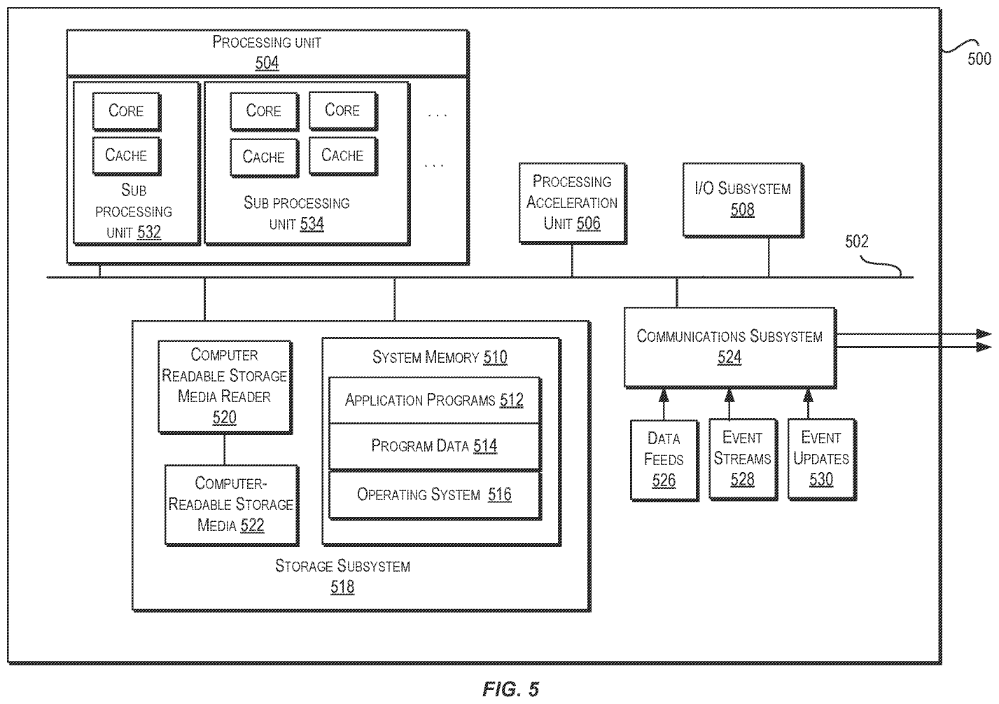

FIG. 5 illustrates an example computer system 500, in which various embodiments described herein may be implemented. The system 500 may be used to implement any of the computer systems described above. As shown in the figure, computer system 500 includes a processing unit 504 that communicates with a number of peripheral subsystems via a bus subsystem 502. These peripheral subsystems may include a processing acceleration unit 506, an I/O subsystem 508, a storage subsystem 518 and a communications subsystem 524. Storage subsystem 518 includes tangible computer-readable storage media 522 and a system memory 510.

Bus subsystem 502 provides a mechanism for letting the various components and subsystems of computer system 500 communicate with each other as intended. Although bus subsystem 502 is shown schematically as a single bus, alternative embodiments of the bus subsystem may utilize multiple buses. Bus subsystem 502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 504, which can be implemented as one or more integrated circuits (e.g., a conventional microprocessor or microcontroller), controls the operation of computer system 500. One or more processors may be included in processing unit 504. These processors may include single core or multicore processors. In certain embodiments, processing unit 504 may be implemented as one or more independent processing units 532 and/or 534 with single or multicore processors included in each processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, some or all of the program code to be executed can be resident in processor(s) 504 and/or in storage subsystem 518. Through suitable programming, processor(s) 504 can provide various functionalities described above. Computer system 500 may additionally include a processing acceleration unit 506, which can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components including a system memory 510, computer-readable storage media 522, and a computer readable storage media reader 520. System memory 510 may store program instructions that are loadable and executable by processing unit 504. System memory 510 may also store data that is used during the execution of the instructions and/or data that is generated during the execution of the program instructions. Various different kinds of programs may be loaded into system memory 510 including but not limited to client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 510 may include a basic input/output system (BIOS) containing basic routines that help to transfer information between elements within computer system 500, such as during start-up.

Computer-readable storage media 522 may represent remote, local, fixed, and/or removable storage devices plus storage media for temporarily and/or more permanently containing, storing, computer-readable information for use by computer system 500 including instructions executable by processing unit 504 of computer system 500.

Computer-readable storage media 522 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments communications subsystem 524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 524 may also be configured to receive data in the form of continuous data streams, which may include event streams 528 of real-time events and/or event updates 530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### AI Training Using Accessibility Data

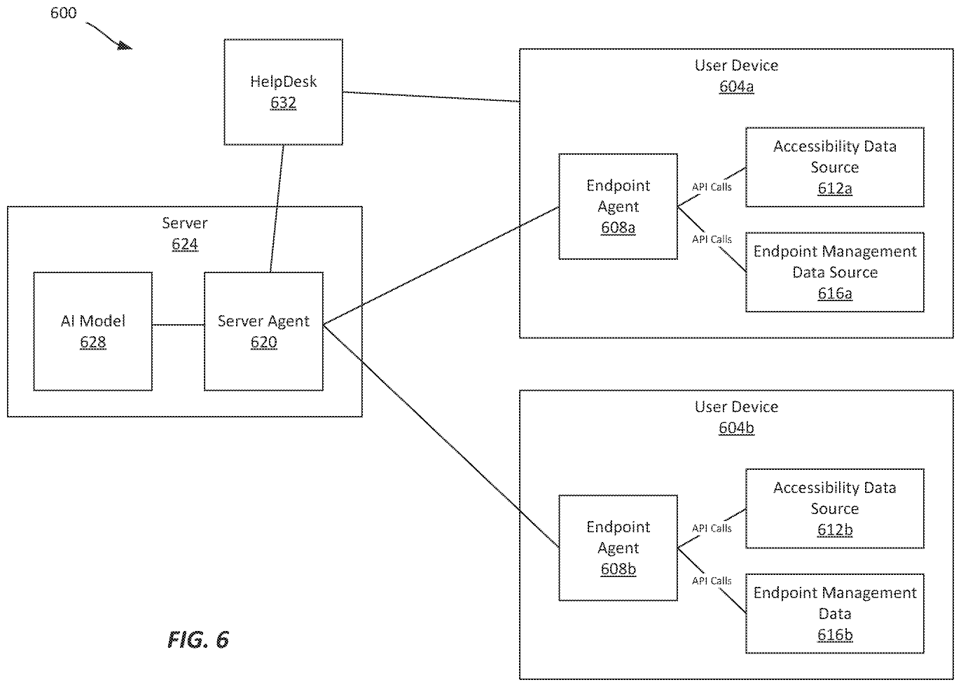

As described above, an end-user (also referred to herein as a “user”) may rely on a helpdesk service (e.g., provided within a cloud computing environment) to troubleshoot an error state occurring on the end-user device (also referred to herein as an “endpoint device”). FIG. 6 is a block diagram illustrating a system architecture 600 for training an AI model to troubleshoot error states on user devices, such as the at least one user device 604 illustrated in FIG. 6, according to at least one embodiment. In the illustrated example, the at least one user device 604 includes a first user device 604a and a second user device 604b. However, the system architecture 600 may include more than two user devices 604 or less than two user devices 604.

Each user device 604 may be substantially similar to the computer system 500 described above with respect to FIG. 5. For example, each user device 604 may include a processing unit substantially similar to the processing unit 504, a processing acceleration unit substantially similar to the processing acceleration unit 506, a I/O subsystem substantially similar to the I/O subsystem 508, a storage subsystem substantially similar to the storage subsystem 518, and/or a communications subsystem substantially similar to the communications subsystem 524.

Each user device 604, or endpoint device 604, is provided with an endpoint agent 608 configured to receive accessibility data from an accessibility data source 612. The endpoint agent 608 receives the accessibility data by making one or more calls via an accessibility application programming interface (API), otherwise referred to herein as an accessibility interface, to request the accessibility data. Calls made via the accessibility API are calls that conform to the accessibility API, which may conform to an accessibility standard.

The accessibility data source 612 is a platform that renders a user interface (“UI”) displayed by the user device 604. For example, the accessibility data source 612 may include an operating system (“OS”) executing on the user device 604, a browser application executing on the user device 604, and/or another software application executing on the user device 604. Accordingly, the accessibility data is generated by the platform executing on the user device 604 during rendering of the UI.

The accessibility data, which is associated with the UI displayed by the user device 604, includes information identifying UI elements in the UI of the user device 604 and/or information identifying UI events in the UI of the user device 604. UI elements may include, for example, windows, buttons, scroll bars, menus, and/or the like. UI events include changes in a state or condition of the UI elements. UI events may be caused by keyboard strokes, mouse clicks, software execution, and/or the like. For example, keyboard strokes may cause text rendered in a UI element to change.

The accessibility data may also be received by an assistive application to perform assistive, or accessibility, functionality. The accessibility functionality may be, for example, functionality beyond that which is offered by the UI rendered on the user device 604 to facilitate user interaction with the UI (e.g., by users with disabilities). Assistive applications may include, but are not limited to, screen magnifiers, screen readers, text-to-speech software, speech recognition software, and/or the like.

The accessibility data (i.e., the information identifying UI elements and/or the information identifying UI events in the UI of the user device 604) is generated based on metadata exposed via the accessibility API. Metadata exposed via the accessibility API is metadata that conforms to the accessibility API, which may conform to a standard, such as an accessibility or UI standard. Metadata generally refers to labels created by, for example, a developer to identify characteristics of UI elements.

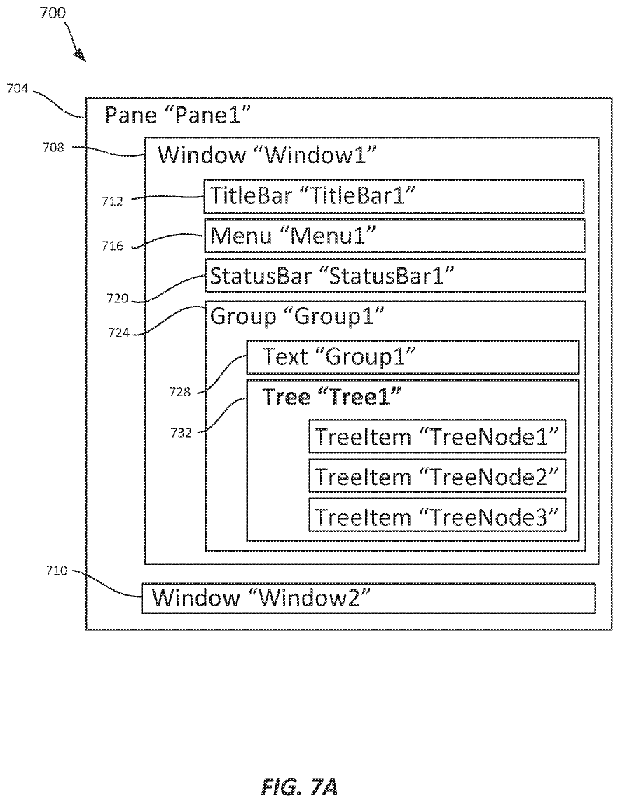

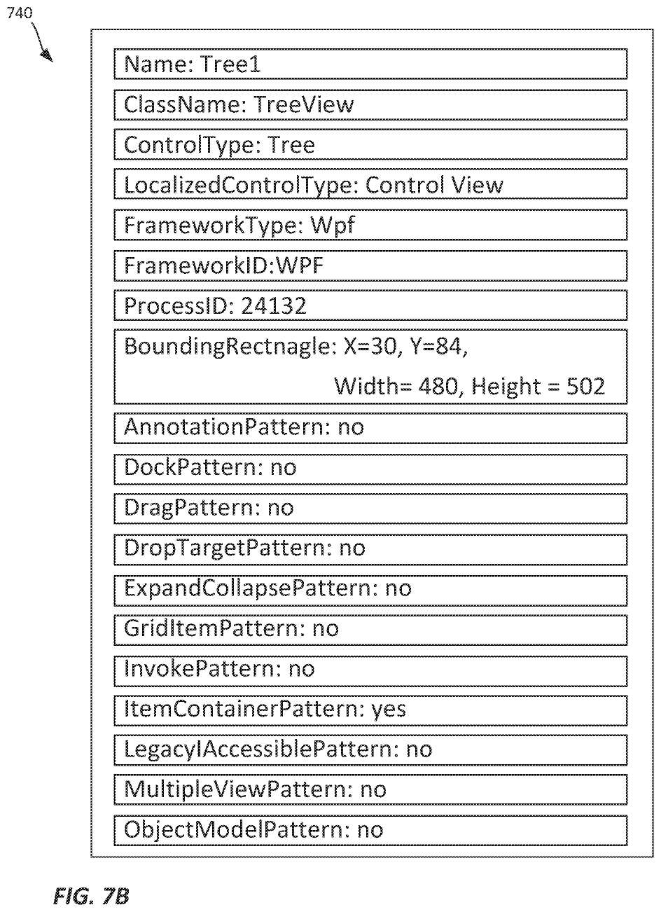

In some instances, the information identifying the UI elements in a UI of the user device 604 is organized as a hierarchical tree. For example, FIGS. 7A and 7B illustrate example accessibility data. FIG. 7A illustrates an example accessibility data tree 700 of accessibility data associated with UI elements of an example UI of user device 604 (i.e., any one of the first user device 604a or the second user device 604b). Each hierarchical level of the hierarchical tree 700 includes at least one node respectively representing a UI element of the example UI and associated metadata for each element. The hierarchical relationships between respective UI elements of the example UI may be specified by the metadata.

For each respective UI element, the metadata may also specify a respective element type of the respective UI element and/or a respective identifier of the respective UI element. For example, as indicated by the hierarchical tree 700, a UI element of the example UI includes a pane-type element 704 identified as “Desktop.”

Each respective UI element may include one or more secondary UI elements. For example, the pane-type UI element may include a first window-type UI element 708 identified as “Window1” and a second window-type UI element 710 identified as “Window2” that are each at a hierarchical level of the hierarchical tree 700 below the pane-type UI element 704. In other words, each hierarchical level of the hierarchical tree 700 includes at least one node respectively representing a UI element.

As further illustrated in FIG. 7A, the first window-type UI element 708 includes, at a lower hierarchical level than the pane-type UI element 708, a TitleBar-type UI element 712 identified as “TitleBar1,” and defining a title bar portion of the window-type UI element 708, a menu-type UI element 716 identified as “Menu1” and defining a menu of the window-type UI element 708, a StatusBar-type UI element 720 identified as “StatusBar1” and defining a status bar of the window-type UI element 708, and a group-type UI element 724 identified as “Group1,” and defining a UI group included in the window-type UI element 708. The group-type UI element 724 further includes a text-type UI element 728 identified as “Group1,” defining text displayed within the group-type UI element 724, and a tree-type UI element 732 displayed within the group-type UI element 724.

For each respective UI element, the metadata may also specify a respective state or condition of the UI element. For example, as illustrated in FIG. 7B, the accessibility data (e.g., the metadata) may also provide additional metadata of a particular UI element (e.g., the tree-type UI element 732 of FIG. 7A). As illustrated in FIG. 7B, additional metadata 740 defining states or conditions of a given UI element may include other identifiers (e.g., an automation identifier, a name, a class name), control information (e.g., a control type, a localized control type), framework information (e.g., a framework type, a framework identifier), process information (e.g., a process identifier), location information of the UI element within the example UI (e.g., coordinates and/or dimensions of the UI element), pattern information of the UI element, and/or the like.

Conditions and/or states of a respective UI element may change, for example, responsive to user interaction with the UI element, responsive to software execution, and/or the like. For example, responsive to a user interacting with a respective UI element to resize the UI element, bounding box information associated with the UI element may change (e.g., coordinates and/or dimensions of the UI element). As described above, UI events include changes in a state or condition of the UI elements. The information identifying UI events (i.e., information included as accessibility data requested by, for example, the endpoint agent 608) may include notifications of such changes in states or conditions of the UI elements.

The metadata associated with the UI elements and/or UI events may be specified in application code of application for which the example UI is being rendered and/or content code of web content for which the example UI is being rendered.

Referring again to FIG. 6, the endpoint agent 608 of each user device 604 is also configured to receive endpoint management data from an endpoint management data source 616 of the user device 604. The endpoint agent 608 may request the endpoint management data by making one or more API calls to the endpoint management data source 616 via an endpoint management API.

The endpoint management data includes state information of the user device 604. For example, the endpoint management data may include configuration information of the user device 604 (how the user device workstation is configured), network information of the user device 604 (e.g., whether and how a virtual private network (“VPN”) is established, Wi-Fi connection information of the user device 604, Ethernet connection information of the user device 604, etc.), user profile information of a logged-in session of the user device 604, process information of the user device 604 (e.g., programs run on and files accessed by the user device 604), and/or other telemetry and log information associated with the user device 604.

Each endpoint agent 608 may provide the requested accessibility data received from the accessibility data source 612 and the endpoint management data received from the endpoint management data source 616 to a server agent 620 residing in a server 624. The server 624 may be an on-site server 624 within the same local network as each user device 604, a cloud-based server 624, or a combination thereof (i.e., a server 624 implemented in a distributed manner). In some instances, the server 624 is implemented as a computer system substantially similar to the computer system 500 described above with respect to FIG. 5. Further, in some instances, functionality provided by the server 624 is included as part of the cloud services 456 described above with respect to FIG. 4.

In some instances, the server agent 620 periodically receives the endpoint management data and/or the accessibility data from each user device 604 (e.g., at predetermined intervals of time). In some instances, the server agent 620 receives the endpoint management data and/or accessibility data from each user device 604 responsive to transmitting a command to the endpoint agent 608 requesting the endpoint management data and/or accessibility data.

For simplicity, functions are described herein as being performed by the server agent 620 or the endpoint agent 608. However, such functions may be performed interchangeably by the endpoint agent 608 or the server agent 620. For example, in some instances, the server agent 620 itself makes the respective API calls to the accessibility data source 612 and/or the endpoint management data source 616. In some instances, rather than the server agent 620 requesting accessibility data from the accessibility data source 612 (e.g., via respective API calls), the accessibility data source 612 pushes the accessibility data to the server agent 620 (e.g., via one or more API calls).

As described above, a user may experience an error in the functionality of an end-user device, such as the first user device 604a of FIG. 6. The error may be, for example, an error state of software running on the first user device 604a. The server agent 620 provides the error state information and the accessibility data of the first user device 604a as training data to an AI model 628 residing in the server 624. The AI model may be, for example, a large language model (“LLM”) that is fine tuned and/or prompt-tuned according to a curated set of error states (e.g., error states extrapolated from accessibility data and/or helpdesk error reporting data), context surrounding those example error states (e.g., endpoint management data and/or accessibility data), and error state solutions. The LLM may be a suitably large model having a minimum number of parameters (e.g., at least 7 billion parameters, at least 25 billion parameters, at least 50 billion parameters, etc.). To fine-tune a pre-trained model, a training data set including the information noted above can be provided to the model (e.g., by defining a path to such training data, which may be stored in one or more object storage buckets on a cloud platform).

Based on the received accessibility data, the AI model 628 may identify error information displayed on the UI of the first user device 604a (e.g., an error window UI element including an error description, an error code, etc. as indicated by metadata of the UI element) and relate the displayed error information to the determined error state. Accordingly, the AI model 628 is trained to infer later occurrences of the error state on both the first user device 604a and other user devices 604 (e.g., the second user device 604b) based on later-received accessibility data.

For example, using the AI model 628, the server agent 620 may determine that second accessibility data received from the second user device 604b (e.g., by way of the server agent 620 and the endpoint agent 608b) includes a similar error window UI having the same error code as previously received by the first user device 604a when the first user device 604a experienced a first error state. Accordingly, based on inferences of the AI model 628, the server agent 620 may detect that the second user device 604b is experiencing an error state that is the same as the first error state previously experienced by the first user device 604a.

In some instances, the error state information provided by the server agent 620 to the AI model 628 as training data is received through a virtual helpdesk service, such as the helpdesk 632 illustrated in FIG. 6. For example, responsive to the first user device 604a experiencing an error, a user may establish a connection to the virtual helpdesk 632 with the first user device 604a in order to report and troubleshoot the error state. The virtual helpdesk 632 may be an internal helpdesk service associated with an organization to which the first user device 604a and the second user device 604b belong. The server agent 620 may be communicatively connected to the virtual helpdesk 632 such that the server agent 620 receives communications between the virtual helpdesk 632 and the first user device 604a. For example, the server agent 620 may monitor the helpdesk 632, or receive a notification from the helpdesk 632 responsive to an error being reported to the helpdesk 632.

In some instances, the AI model 628 is further trained based on a solution to the error state. For example, an error state may be associated with a known solution, or a solution derived based on error reporting communications received via the helpdesk service 632. For example, the server agent 620 may train the AI model 628 based on an error state detected on the first user device 604a, accessibility data of the first user device 604a, and a solution to the error state implemented on the first user device 604a. In such instances, the server agent may later detect (e.g., using the AI model 628), based at least on accessibility data received from the second user device 604b, the occurrence of the error state on the second user device 604b. Responsive to detecting the occurrence of the error state using the AI model 628, the server agent 620 may output, based on at least the AI model 628, a command to the endpoint agent 608b executing on the second user device 604b to implement the solution to error state on the second user device 604b.

The solution may include, for example, restarting at least one application executing on the second user device 604b, modifying an application configuration of at least one application of the second user device 604b, modifying a network configuration of the second user device 604b, and/or the like.

In some instances, the server agent 620 also provides endpoint management data to the AI model 628 as training data for detecting and troubleshooting error states. For example, the server agent 620 may train the AI model 628 using the endpoint management data received from the first user device 604a, the accessibility data of the first user device 604a, the error state of the first user device 604a, and the solution to the error state on the first user device 604a. Accordingly, the server agent 620 may later predict, using the AI model 628, an occurrence of the error state on another user device (e.g., the second user device 604b) based on endpoint management data received from the second user device 604b. For example, the server agent 620 may determine that a particular configuration of the first user device 604a resulted in the error state, and that the second user device 604b has the same configuration. In such instances, the server agent 620 may output, based on at least the AI model 628, a command to the endpoint agent 608b executing on the second user device 604b to preemptively implement the solution to the error state on the second user device 604b.

After outputting a command to implement a solution to an error state on the second user device 604b (e.g., responsive to detecting or predicting the error state on the second user device 604b), the server agent 620 may receive new endpoint management data from the second user device 604b and train the AI model 628 based on the new endpoint management data. The AI model 628 may therefore be trained based on the results of an implementation of a solution on the second user device 604b, such that the AI model 628 may further improve on known solutions to error states.

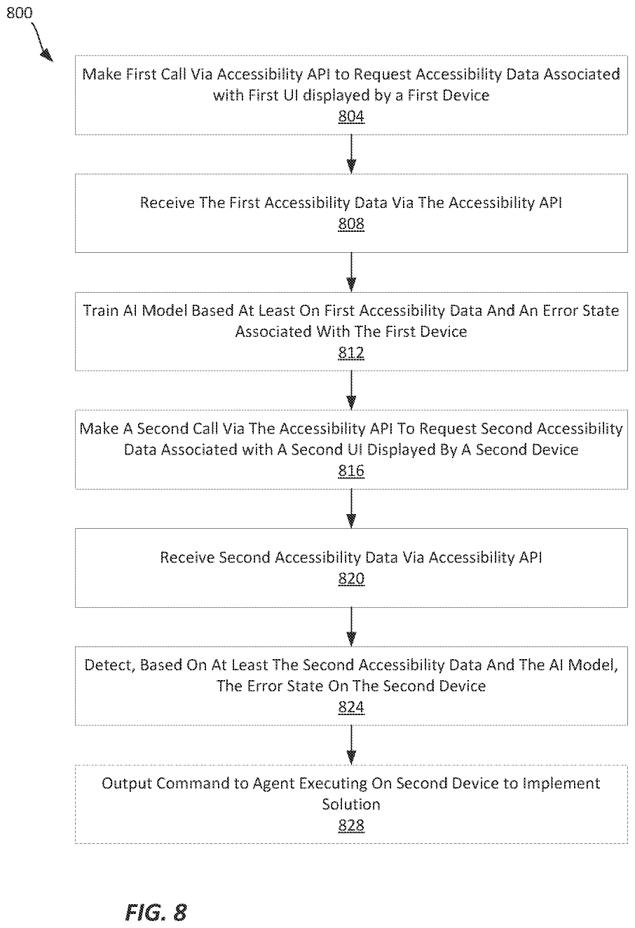

Referring now to FIG. 8, an example method 800 for training the AI model 628 to detect error states is illustrated. The method 800 includes making (e.g., with the server agent 620 in conjunction with the first endpoint agent 608a) a first call via an accessibility API to request accessibility data associated with a first UI displayed by the first user device 604a (at block 804). The server agent 620 receives the first accessibility data via the accessibility API (at block 808), and trains, based on at least the first accessibility data and an error state associated with the first user device 604a, the AI model 628 (at block 812). As described above, in some instances, the error state of the first user device 604a is reported through the helpdesk service 632. Alternatively, or in addition, the server agent 620 is configured to determine the error state of the first user device 604a based on at least first endpoint management data received from the first user device 604a.

The method 800 further includes making (e.g., with the server agent 620 in conjunction with the second endpoint agent 608b) a second call via the accessibility API to request second accessibility data associated with a second UI displayed by the second user device 604b (at block 816). The server agent 620 receives the second accessibility data via the accessibility API (at block 820), and detects, based on at least the second accessibility data and the AI model 628, the error state on the second user device 604b (at block 824).

As described above, in some instances, the server agent 620 further trains the AI model 628 (e.g., at block 812) based at least on a solution to the error state. In such instances, the server 624 may output a command to an agent executing on the second user device (e.g., the second endpoint agent 608b) to implement the solution to the error state (at block 828).

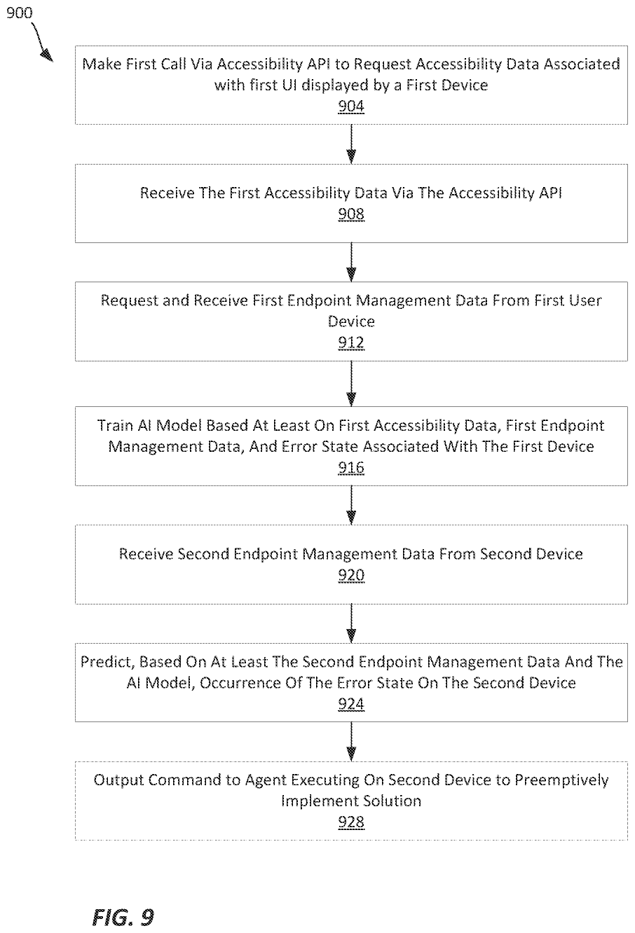

Referring now to FIG. 9, an example method 900 for training the AI model 628 to predict error states is illustrated. The method 900 includes making (e.g., with the server agent 620 in conjunction with the first endpoint agent 608a) a first call via an accessibility API to request accessibility data associated with a first UI displayed by the first user device 604a (at block 904), and receiving, with the server agent 620, the first accessibility data via the accessibility API (at block 908). The server agent 620 also requests and receives (e.g., using the first endpoint agent 608a) first endpoint management data from the first user device 604a (at block 912).

The server agent 620 trains the AI model 628 based on at least the first accessibility data, an error state associated with the first user device 604a, and the first endpoint management data (at block 916). As described above, in some instances, the error state of the first user device 604a is reported through the helpdesk service 632. Alternatively, or in addition, the server agent 620 is configured to determine the error state of the first user device 604a based on at least first endpoint management data received from the first user device 604a.

The method 900 further includes requesting and receiving (e.g., with the server agent 620 in conjunction with the second endpoint agent 608b) second endpoint management data from the second user device 604b (at block 920). The server agent 620 predicts, based on at least the AI model 628 and the second endpoint management data, an occurrence of the error state on the second user device 604b (at block 924).

As described above, in some instances, the server agent 620 further trains the AI model 628 (e.g., at block 916) based at least on a solution to the error state. In such instances, the server 624 may output a command to an agent executing on the second user device (e.g., the second endpoint agent 608b) to preemptively implement the solution to the error state (at block 928).

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. An electronic device comprising:
at least one electronic processor configured to:
make a first call via an accessibility application programming interface (“API”) to request first accessibility data associated with a first user interface (“UI”) displayed by a first device;
receive the first accessibility data via the accessibility API, the first accessibility data comprising at least one of (a) information identifying one or more UI elements in the first UI or (b) information identifying one or more UI events in the first UI;
train, based on at least the first accessibility data and an error state associated with the first device, an artificial intelligence (“AI”) model;
make a second call via the accessibility API to request second accessibility data associated with a second UI displayed by a second device;
receive the second accessibility data via the accessibility API, the second accessibility data comprising (a) information identifying one or more UI elements in the second UI or (b) information identifying one or more UI events in the second UI; and
detect, based on at least the second accessibility data and the AI model, the error state on the second device.

2. The electronic device of claim 1, wherein the error state of the first device is reported through a helpdesk service.

3. The electronic device of claim 1, wherein the at least one electronic processor is further configured to determine the error state of the first device based on at least first endpoint management data, the first endpoint management data including state information of the first device.

4. The electronic device of claim 1, wherein the AI model is further trained based on at least a solution to the error state, and wherein the at least one electronic processor is further configured to:
output, based on at least the AI model, a command to an agent executing on the second device to implement the solution on the second device.

5. The electronic device of claim 4, wherein the solution includes at least one selected from a group consisting of restarting at least one application executing on the second device, modifying an application configuration of at least one application of the second device, and modifying a network configuration of the second device.

6. The electronic device of claim 1, wherein the AI model is further trained based on first endpoint management data and a solution to the error state, the first endpoint management data including state information of the first device,
wherein the at least one electronic processor is further configured to:
predict, based on at least the AI model and second endpoint management data including state information of a third device, an occurrence of the error state on the third device; and
output, based on at least the AI model, a command to an agent executing on the third device to preemptively implement the solution on the third device.

7. The electronic device of claim 6, wherein the at least one electronic processor is further configured to:
receive third endpoint management data after outputting the command, the third endpoint management device including state information of the third device; and
train the AI model based on at least the third endpoint management data.

8. The electronic device of claim 1, wherein the information identifying the one or more UI elements in the first UI includes at least one selected from the group consisting of: (a) a respective element type of the one or more UI elements in the first UI, (b) a respective identifier of the one or more UI elements in the first UI, or (c) a respective state or condition of the one or more UI elements in the first UI.

9. The electronic device of claim 1, wherein the information identifying the one or more UI elements in the first UI is organized as a hierarchical tree.

10. The electronic device of claim 9, wherein
the one or more UI elements in the first UI comprises a first UI element that includes a second UI element;
the hierarchical tree comprises a first hierarchical level that is above a second hierarchical level;
the first hierarchical level includes a first node representing the first UI element; and
the second hierarchical level includes a second node representing the second UI element.

11. The electronic device of claim 1, wherein the information identifying the one or more UI events in the first UI includes one or more notifications of changes in states or conditions of the UI elements in the first UI.

12. The electronic device of claim 1, wherein the first call made via the accessibility API is made to a platform rendering the first UI.

13. The electronic device of claim 12, wherein the platform includes one of an operating system executing on the first device or a browser application executing on the first device.

14. The electronic device of claim 1, wherein the first accessibility data is generated based on metadata associated with the one or more UI elements in the first UI, the metadata being exposed via the accessibility API.

15. The electronic device of claim 14, wherein the metadata is specified in one of (a) application code of application for which the first UI is being rendered or (b) content code of web content for which the first UI is being rendered.

16. The electronic device of claim 14, wherein the metadata specifies hierarchical relationships between the one or more UI elements in the first UI.

17. The electronic device of claim 1, wherein the first accessibility data is generated by a platform executing on the first device during rendering of the first UI.

18. A method for training an artificial intelligence (“AI”) model for error troubleshooting, the method comprising:
making a first call via an accessibility application programming interface (“API”) to request first accessibility data associated with a first user interface (“UI”) displayed by a first device;
receiving the first accessibility data via the accessibility API, the first accessibility data comprising at least one of (a) information identifying one or more UI elements in the first UI or (b) information identifying one or more UI events in the first UI;
training, based on at least the first accessibility data and an error state associated with the first device, the AI model;
making a second call via the accessibility API to request second accessibility data associated with a second UI displayed by a second device;
receiving the second accessibility data via the accessibility API, the second accessibility data comprising (a) information identifying one or more UI elements in the second UI or (b) information identifying one or more UI events in the second UI; and
detecting, based on at least the second accessibility data and the AI model, the error state on the second device.

19. The method of claim 18, further comprising:
training the AI model based on at least a solution to the error state; and
outputting, based on at least the AI model, a command to an agent executing on the second device to implement the solution on the second device.

20. An electronic device comprising:
at least one electronic processor configured to:
make a first call via an accessibility application programming interface (“API”) to request first accessibility data associated with a first user interface (“UI”) displayed by a first device;
receive the first accessibility data via the accessibility API, the first accessibility data comprising at least one of (a) information identifying one or more UI elements in the first UI or (b) information identifying one or more UI events in the first UI;
train an artificial intelligence (“AI”) model based on at least the first accessibility data, an error state associated with the first device, and endpoint management data associated with the first device, the endpoint management data including state information of the first device; and
predict, based on at least the AI model and second endpoint management data including state information of a second device, an occurrence of the error state on the second device.
